(19) United States
(12) Patent Application Publication
(10) Pub. No.: US 2009/0113211 A1
(43) Pub. Date: Apr. 30, 2009

(54) PROCESSING UNIT INCLUDING A WIRELESS MODULE AND METHOD THEREOF

(76) Inventors: Chun-Hung Liu, Taichung County (TW); Jyh-Ming Lin, Hsinchu City (TW); Min-Chih Hsuan, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 11/933,318

(22) Filed: Oct. 31, 2007

(51) Int. Cl. G06F 15/76; G06F 9/02; H04L 9/28

(52) U.S. Cl. 713/189; 712/1; 712/28; 712/E09.002

(57) ABSTRACT

A processing unit includes a processing core and a wireless module directly connected to the processing core, wherein the wireless module is for providing wireless communications to the processing core. A multi-processor system includes a first processing unit having a first processing core and a first wireless module directly connected to the first processing core, the first wireless module for providing wireless communications to the first processing core; a second processing unit having a second processing core and a second wireless module directly connected to the second processing core, the second wireless module for providing wireless communications to the second processing core; and a wireless link between the first and second wireless modules; wherein the first processing unit is for communicating with the second processing unit via the wireless link.

### BACKGROUND OF THE INVENTION

1. Field of the Invention

The present invention relates to processors, and more particularly, a processing unit with a wireless module for wireless communication and a method thereof.

2. Description of the Prior Art

Today's electronic devices are increasingly being integrated with wireless communications capabilities. Coupling a wireless peripheral to a processor of the electronic device typically brings about these wireless functions, as shown in FIG. 1, and such a design satisfies the majority of common-use applications for electronic devices 100 with wireless needs. Certain applications, however, require tighter control over the processor 110 of the electronic device 100, including interrupting the processor 110 for high-priority tasks.

As an example in related art, during debugging or development of a new system, an ICE (In-Circuit Emulator) is typically utilized. ICE generally requires contact to the processor of the test system through a pre-defined interface such as JTAG and Enhanced JTAG. Physical contact to the processor is necessary, however, and the debugging tools require connecting cables (not shown), correct cables, and appropriate signal voltage levels before debugging can commence.

### SUMMARY OF THE INVENTION

It is therefore an objective of the present invention to solve the aforementioned problems, and to provide a processor which includes wireless communications capabilities with direct control of the processor.

According to a first exemplary embodiment of the present invention, a processing unit is disclosed comprising a processing core, and a wireless module directly connected to the processing core, the wireless module for providing wireless communications to the processing core.

According to another exemplary embodiment of the present invention, a multi-processor system is disclosed comprising a first processing unit having a first processing core and a first wireless module directly connected to the first processing core, the first wireless module for providing wireless communications to the first processing core; a second processing unit having a second processing core and a second wireless module directly connected to the second processing core, the second wireless module for providing wireless communications to the second processing core; and a wireless link between the first and second wireless modules; wherein the first processing unit is for communicating with the second processing unit via the wireless link.

According to a third exemplary embodiment of the present invention, a method of providing wireless communications to a processing unit is disclosed comprising providing a processing core; and directly connecting a wireless module to the processing core.

The foregoing has outlined rather broadly the features and technical advantages of the present invention in order that the detailed description of the invention that follows may be better understood. Additional features and descriptions of the present invention will be described hereinafter, which form the subject of the claims of the present invention.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a diagram of a device with wireless communications according to related art.

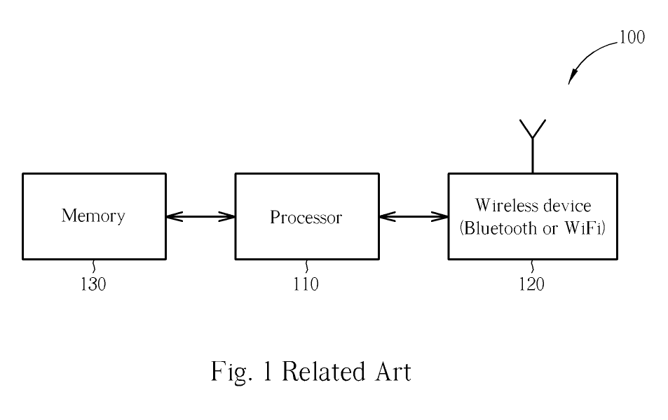

FIG. 2 is a block diagram according to an embodiment of the present invention.

FIG. 3 shows two wireless communications configurations according to embodiments of the present invention.

FIG. 4 illustrates a flowchart for establishing communications between wireless modules in one embodiment of the present invention.

### DETAILED DESCRIPTION

To solve the aforementioned problems and limitations, one objective of the present invention is to provide a processor which includes wireless communications capabilities with direct control of the processor.

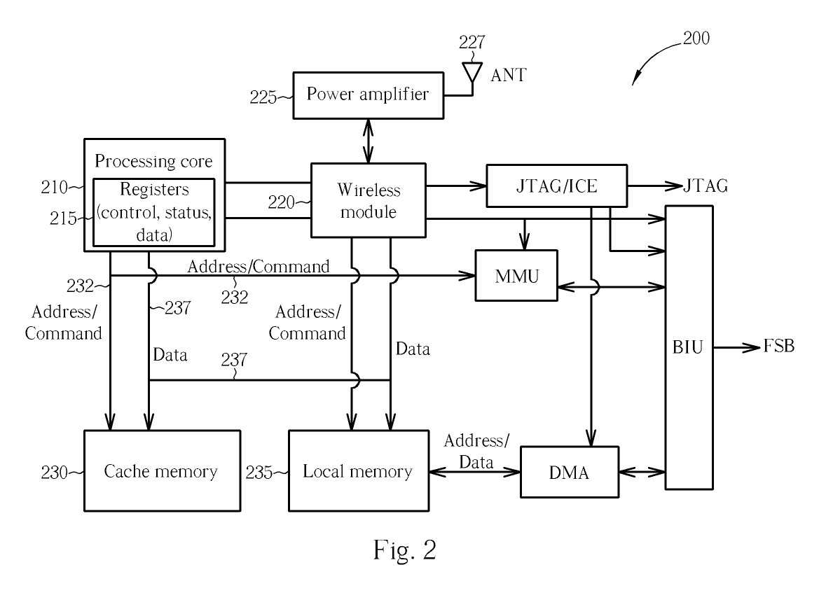

Please refer to FIG. 2, which shows a block diagram of an embodiment of the present invention. The processing unit 200 is for executing commands of an electronic system, and comprises: a processing core 210 having registers 215, a wireless module 220, a power amplifier 225, an RF antenna 227, a cache memory 230 and local memory 235. The processing core 210 is coupled to the wireless module 220, which is also connected to the power amplifier 225. The power amplifier 225 is coupled to antenna 227. Both the processing core 210 and the wireless module 220 are coupled to both the cache memory 230 and local memory 235 via address/command lines 232 and data lines 237. The registers 215 comprise a plurality of control registers, status registers, and data registers for the wireless module 220. The control registers are utilized for setting and configuring (such as enabling and disabling) the wireless module 220. The status registers hold information of the wireless module 220, some of which, when combined with settings stored in the control registers, will trigger interrupt events of the processing core 210 or other operations for moving data to or from the cache memory 230 or local memory 235. Data registers store data received from or to be transmitted by the wireless module 220. Other components in FIG. 2 are not the focus of the present invention, and have not been numerically labeled.

Please note that in one embodiment, all components of the wireless module 220 are embedded in the processing unit 200; that is, the wireless system consisting of the wireless module 220, power amplifier 225, and antenna 227 are included on the processing unit 200 chip. In other embodiments, one or more components of the wireless system 220 are external to the processing unit but remain coupled as shown in FIG. 2; for example, in another embodiment, the antenna 227 is a wire antenna attached outside of the processing unit 200, instead of a chip antenna. As another example, the antenna 227 and the power amplifier 225 are external to the processing unit 200 packaging. These implementations depend on the designer's requirements.

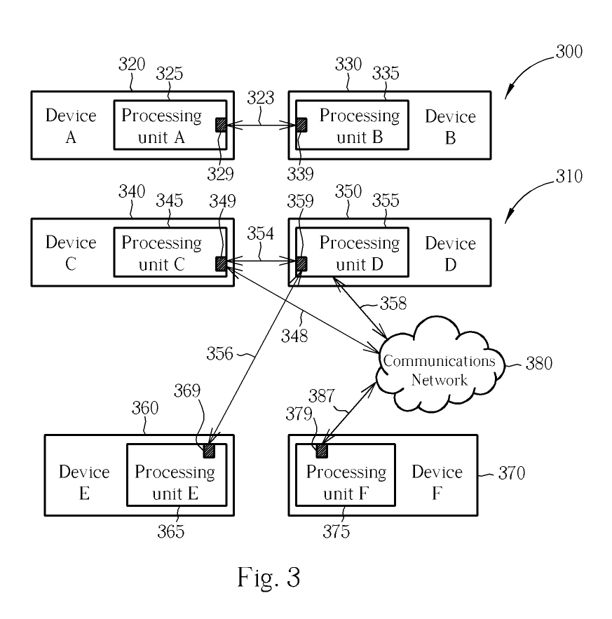

The wireless module 220 provides the processing core 210 in the processing unit 200 (such as a CPU) with direct wireless communications to another processing core 210, or to a plurality of other processing cores. In one of two examples in FIG. 3, the plurality of processing cores 329, 339 (inside processing units 325, 335, respectively, which are in turn respectively inside devices 320 and 330) are connected in a host-device (or master-slave) configuration via wireless link 323. In another example, the processing cores 349, 359, 369, and 379 (and by extension, their respective processing units 345, 355, 365, 375 inside of devices 340, 350, 360 and 370, respectively) are configured in a multi-processor network via wireless links 354, 348, 358, 356, and 387; some of the links in this example are transmitted wirelessly and over a communications network 380. This communications network may contain bridges and other intermediary equipment as necessary in order to obtain the same goal. Again, the processing units 345, 355, 365, 375 operate in master and slave configurations. It should be noted that there could be several processing units 345, 355, 365 acting as slaves and one processing unit 375 operating as a master in the multi-processor system 310.

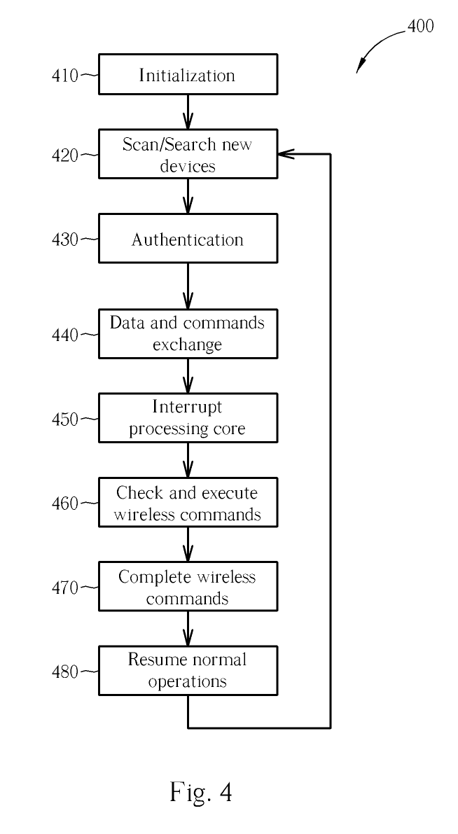

Please refer to FIG. 4, which shows a flowchart 400 for establishing communications between wireless modules 220 of two processing cores 210. A method of the present invention in steps as listed below:

Step 410: Initialization.

Step 420: Scan/Search new devices.

Step 430: Authentication.

Step 440: Data and commands exchange to data registers.

Step 450: Interrupt processing core.

Step 460: Check and execute wireless commands from data registers.

Step 470: Complete wireless commands.

Step 480: Resume normal operations in processing cores.

Step 410 initializes the processing core for utilization. In Step 420, a wireless device searches for another device and sets up the communication link. In Step 430, a wireless connection is established and the first and second processing cores are authenticated to each other. Since the concept of authentication and establishing a wireless communications channel is commonly known to those skilled in the art, further description is omitted. Once, the wireless link is ready, the wireless module receives the packet in Step 420 and puts them in the data registers, and then notifies the processing core according the control register settings. For a large number of packets, the wireless module can invoke DMA to move packets from data registers to local memory. The first processing core assumes the role of master in Step 450, whereas the second processing core takes the slave role. Commands to be executed on the slave processing core are transmitted wirelessly in Step 460 until they have been completed and no further commands are to be executed (Step 470). Finally, normal operations are resumed in Step 480 for both the first and second processing cores. By this flowcharted method, a first (master) processing core 210 interrupts the operations of a second (slave) processing core and instructs the slave processing core to execute commands of specific types.

The wireless module 220 communicates with one or more of a specific set of instructions between multiple processing cores, which include: interrupt instructions for specific execution control over the processing core 210; encryption and decryption instructions for secure communications and protocols; debugging instructions for applying step-by-step execution in the processing core 210 as well as other functions during development of the processing core 210 and other peripherals, such as setting and resetting processor execution breakpoints; packing and unpacking instructions for data packet manipulation; and compressing and decompressing instructions for data transfer efficiency.

In the related art, the processing core 210 typically instructs a wireless peripheral to transmit or receive certain data, and will interrupt its operations as necessary according to the needs of the processing unit 200. But such an architecture requires the proper device driver for the wireless peripheral as well as compatible input-output (10) interface before data can be transmitted or received. By implementing the wireless module 220 directly connecting to the processing core 210 according to the present invention, data communication interrupts from the wireless module 220 take priority and are processed immediately. For example, when a processing unit 200 is affected by a virus or other malicious code and this condition is detected by another processing unit, an interrupt request and command is sent wirelessly to processing unit 200 to immediately suspend operations, thereby preventing further infection or damage. Furthermore, another processing unit sends (for example) a remedy software patch or program to eliminate the threatening virus. In related art, the wireless peripheral cannot immediately seize control and it is possible the malicious code will ignore all interrupt requests from peripherals. Another example for this embodiment of the present invention is the secure remote control of a device (in which the processing unit 200 resides): in an intelligent security grid network, the disabling of one alarm sensor will trigger a warning signal to other connected sensors. In yet another example, law enforcement and emergency services vehicles (e.g., police, ambulances, fire engines, etc.) are equipped with devices containing exemplary processing units 200 of the present invention and interrupt normal operations of traffic signals in order to facilitate their transportations and urgencies.

The wireless module 220 directly connected to the processing core 210 also includes, in one embodiment, encryption and decryption instructions for secure communications and protocols. The implementation of encryption and decryption between processing cores allows secure communication between processing units and their devices. Moreover, in another embodiment of the present invention, each processing core 210 contains a unique identifier utilized for identification and authentication that is assigned at the time of manufacturing (via a one-time-programming method such as laser trimming) which cannot be duplicated or changed thereafter. An additional advantage lies in that the communications between the processing core 210 and its wireless module 220 cannot be intercepted as is easily done between a related processing core and a wireless peripheral.

A further application of an embodiment of the present invention utilizes debugging instructions during the development of the processing core 210 and other peripherals; this is also applicable during normal operations of the processing core 210 as necessary. The inclusion of debugging instructions permits a debugger or compiler device to apply execution instructions as well as other functions in the processing core 210 to monitor and modify the operations of the processing core 210. Such instruction execution is controlled, for instance, by setting and resetting processor execution breakpoints via breakpoint register 215 (or multiple breakpoint registers) for halting operations of the processing core 210. In one example, a monitoring program is loaded to the processing core 210 to report real-time information about the processing core 210 during execution and to allow the debugger device to control step-by-step program execution.

Other functions invoked by the wireless module 220, such as packing and unpacking instructions and compressing and decompressing instructions, are utilized for the activities of data communications, data packet manipulation, and for greater data transfer efficiency and security.

From the above description, the present embodiments of the present invention illustrate at least the advantages of being easier to wirelessly debug and control a processing core, to invoke a top-priority interrupt and take control of a processing core, and provide secure communications between processing cores. Furthermore, lower cost of manufacturing due to the integration of a wireless module into the processing core (chip), as well as smaller size and circuit board real estate can be realized from implementing the present invention.

It should be noted that although a central processing unit (CPU) for a computing device is presented in this example, the application to a CPU is not meant to be a limitation of the scope of this invention. The present invention can be applied to any processing unit which in related art has a wireless peripheral and such applications and embodiments also obey the spirit of and should be considered with the scope of the present invention.

After reviewing this first embodiment of the present invention, other applications and implementations will be obvious to those skilled in the art, and should be included within the scope of the present invention.

Those skilled in the art will readily observe that numerous modifications and alterations of the device and method may be made while retaining the teachings of the invention.

What is claimed is:

1. A processing unit comprising:
a processing core; and
a wireless module directly connected to the processing core, the wireless module for providing wireless communications to the processing core.

2. The processing unit of claim 1, further comprising status registers and control registers and data registers of the processing core for the wireless module, wherein the wireless module is further for directly setting the control registers to thereby control operations of the processing core, and for storing data in the data registers to be transmitted and received.

3. The processing unit of claim 1, wherein the processing core is for providing encryption and decryption capabilities, and the wireless module is further for passing encryption and decryption instructions to the processing core.

4. The processing unit of claim 1, wherein the processing core is for providing packing and unpacking capabilities, and the wireless module is further for passing packing and unpacking instructions to the processing core.

5. The processing unit of claim 1, wherein the processing core is for providing compressing and decompressing capabilities, and the wireless module is further for passing compressing and decompressing instructions to the processing core.

6. The processing unit of claim 1, wherein the processing core is for providing interrupt capabilities, and the wireless module is further for passing interrupt instructions to the processing core.

7. The processing unit of claim 1, wherein the processing core is for providing debugging capabilities, and the wireless module is further for passing debugging instructions to the processing core.

8. The processing unit of claim 1, wherein the processing unit further comprising a unique identifier utilized for authentication purposes; or
the processing unit is a central processing unit (CPU) for executing commands of an electronic system; or
the processing core is for acting as a master and as a slave in a multi-processor system.

9. A multi-processor system comprising:
a first processing unit having a first processing core and a first wireless module directly connected to the first processing core, the first wireless module for providing wireless communications to the first processing core;
a second processing unit having a second processing core and a second wireless module directly connected to the second processing core, the second wireless module for providing wireless communications to the second processing core; and
a wireless link between the first and second wireless modules;
wherein the first processing unit is for communicating with the second processing unit via the wireless link.

10. The multi-processor system of claim 9, wherein each processing unit of the multi-processor system further includes status registers and control registers and data registers for each wireless module, and the first and second wireless modules are further for directly setting the control registers to thereby control operations of the processing core of the processing unit, and for storing data in the data registers to be transmitted and received.

11. The multi-processor system of claim 9, wherein the first processing unit is a master and the second processing unit is a slave in the multi-processor system.

12. The multi-processor system of claim 11, wherein the first processing unit is for providing encryption and decryption instructions to the second processing unit via the wireless link.

13. The multi-processor system of claim 11, wherein the first processing unit is for providing packing and unpacking instructions to the second processing unit via the wireless link.

14. The multi-processor system of claim 11, wherein the first processing unit is for providing compressing and decompressing instructions to the second processing unit via the wireless link.

15. The multi-processor system of claim 11, wherein the first processing unit is for providing interrupt instructions to the second processing unit via the wireless link.

16. The multi-processor system of claim 11, wherein the first processing unit is for providing debugging instructions to the second processing unit via the wireless link.

17. The multi-processor system of claim 11, further comprising additional processing units acting as slaves in the multi-processor system.

18. A method of providing wireless communications to a processing unit, the method comprising:
providing a processing core; and
directly connecting a wireless module to the processing core.

19. The method of claim 18, further comprising:
providing status registers and control registers and data registers of the processing core;
directly setting the control registers by the wireless module to thereby control operations of the processing core; and
directly storing data by the wireless module in the data registers to be transmitted and received.

20. The method of claim 18, further comprising:
providing encryption and decryption capabilities by the processing core; and
passing encryption and decryption instructions to the processing core by utilizing the wireless module.

21. The method of claim 18, further comprising:
providing packing and unpacking capabilities by the processing core; and
passing packing and unpacking instructions to the processing core by utilizing the wireless module.

22. The method of claim 18, further comprising:
providing compressing and decompressing capabilities by the processing core; and
passing compressing and decompressing instructions to the processing core by utilizing the wireless module.

23. The method of claim 18, further comprising:
providing interrupt capabilities by the processing core; and
passing interrupt instructions to the processing core by utilizing the wireless module.

24. The method of claim 18, further comprising:
providing debugging capabilities by the processing core; and
passing debugging instructions to the processing core by utilizing the wireless module.

25. The method of claim 18, wherein the processing unit further includes a unique identifier, and the method further comprises utilizing the unique identifier for authentication purposes; or
the processing unit is a central processing unit (CPU), and the method further comprises executing commands of an electronic system utilizing the central processing unit; or
the processing core is for acting as a master and as a slave in a multi-processor system.
